(19) United States
(12) Patent Application Publication
(10) Pub. No.: US 2024/0076202 A1
(43) Pub. Date: Mar. 7, 2024

(54) LITHIUM ION BATTERY WITH LOW CAPACITY LOSS

(71) Applicant: XTC New Energy Materials (Xiamen) Co., Ltd., Xiamen (CN)

(72) Inventors: Bolie Yu, Xiamen (CN); Guozhen Wei, Xiamen (CN); Zhen Lin, Xiamen (CN); Nengjian Xie, Xiamen (CN)

(73) Assignee: XTC New Energy Materials (Xiamen) Co., Ltd., Xiamen (CN)

(21) Appl. No.: 17/929,102

(22) Filed: Sep. 1, 2022

(51) Int. Cl. C01G 53/00; H01M 10/0525

(52) U.S. Cl. CPC C01G 53/50; H01M 10/0525; C01P 2006/40

(57) ABSTRACT

The present invention discloses a lithium ion battery with low capacity loss, which comprises an cathode material, a anode material and an electrolyte. The cathode material has a chemical formula Li_{(9x+2y+z)}Mn_{y}Me_{z}O_{(3y+z)}N₂ₓX₃ₓ (xLi₉N₂X₃·yLi₂MnO₃·zA), and has advantages such as stable performance, low surface residue, and high dilithiation capacity. The preparation of the cathode material comprises the steps of: synthesis of a precursor from a metal salt and a manganese compound by chemical co-precipitation, followed by, sequentially, heat treatment and crushing; and repeated lithium supplementation and multi-stage sintering to form the cathode material. The method for preparing the cathode material is simple. By repeated lithium supplementation and sintering, Li₃N is inserted into the lattice of the material. Li₉N₂X₃ forms a eutectic with the base material, which further reduces the surface residue, improves the storage and cycling performance of the material. The components complement each other and coexist synergistically, and the prepared cathode material has the advantages of high dilithiation capacity and low capacity loss.

### TECHNICAL FIELD

The present invention belongs to the technical field of lithium ion batteries, and specifically relates to a delithiating material, especially to a high delithiating material and its preparation method.

### BACKGROUND

In order to improve the energy density of lithium ion batteries, silicon anode materials with high specific capacities are gradually becoming the choice of battery companies and material suppliers, and are becoming one of the most potential anode materials for next generation lithium ion batteries. However, relatively large volume expansion and relatively low initial coulombic efficiency of silicon anodes limit their practical applications. Since the coulombic efficiency of the cathode is much higher than that of the anode, the capacity of the cathode material cannot be fully utilized, resulting in waste of the cathode material and reduction of the battery capacity. This is mainly because a solid electrolyte film, or an SEI film, is formed on the surface of the anode material during the initial charging process, which consumes lithium ions, while lithium ions are almost entirely supplied by the cathode material in the battery. Therefore, the concept of “lithium supplementation” was proposed. By “lithium supplementation” on the anode, the cathode or the separator, the lithium ions consumed by the formation of the SEI film during the initial charging process of the battery are compensated.

The process of lithium supplementation on the cathode comprises adding a material with a high lithium capacity to the cathode during the homogenization process. During the charging process, excess lithium element is extracted from the high lithium capacity cathode material and inserted into the anode to compensate the irreversible lithium capacity loss in the initial charge and discharge.

Therefore, a lithium source is sought outside the cathode material, so that the lithium ions consumed in the formation of the SEI film are from the external lithium source, so as to compensate the waste of lithium ions de-intercalated from the cathode material, and finally improve the capacity of the full battery. The process of providing lithium from an external lithium source is called dilithiation, and the external lithium source used on the cathode material is called a delithiating material.

Delithiating materials have been a research hotspot in the field of lithium batteries in recent years. Patent CN107221650B describes a lithium supplementing additive and its preparation method. The additive is prepared by mixing various materials in certain proportions, and sintering in a plurality of steps. However, the purity of the active ingredient is relatively low, and some products have small particle sizes and high activities, making it difficult to store. According, a further passivation treatment is required, and the process is complicated. Patent application CN107819113A discloses a lithium supplementing additive and its preparation method and application. The lithium supplementing additive has a core-shell structure, in which the core material is a conductive carbon material, and the shell material is lithium oxide. Lithium oxide is deposited on the surface of the conductive carbon material. Nano-sized lithium oxide particles form a nano-layer shell. The preparation method is complicated and difficult.

In the prior art and existing patents, the preparation methods of the delithiating material are simple, but the prepared delithiating material has low purity and low dilithiation capacity, and cannot fully meet the problem of lithium ion loss in current lithium ion batteries. Therefore, researches on a delithiating material with high lithium supplementing capacity and a preparation process suitable for industrialization have become a current research focus.

### SUMMARY OF THE INVENTION

The main purpose of the present invention is to overcome the defects of the prior art, and to provide a delithiating material and its preparation method. The delithiating material is characterized by stable performance, easy storage, high dilithiation capacity, and low capacity loss.

To realize the above purpose of the invention, the present invention provides the following technical solutions.

According to one aspect of the present application, there is provided a delithiating material with a chemical formula Li_{(9x+2y+z)}Mn_{y}Me_{z}O_{(3y+z)}N₂ₓX₃ₓ (xLi₉N₂X₃·yLi₂MnO₃·zA), wherein 0<x≤0.25, 0<y≤0.5, 0.5≤z≤1, Me is Fe, Ni or Co, A is one or more selected from the group consisting of Li₅FeO₄, Li₂NiO₂, Li₆CoO₄ and Li₆MnO₄, and X is a group VIIA element.

According to an embodiment of the present invention, each of x, y and z is an integral multiple of 0.05.

According to an embodiment of the present invention, X is one or more selected from the group consisting of F, Cl, Br and I.

According to another aspect of the present invention, there is provided a method for preparing the above delithiating material, comprising:
S1, preparing a precursor from a metal salt and a manganese compound by chemical co-precipitation, followed by, sequentially, heat treatment in a nitrogen atmosphere, crushing and sieving;
S2, adding the sieved precursor obtained in step S1 to lithium powder and lithium halide, mixing uniformly in a nitrogen atmosphere, pressing into a film, and then sintering under pressure in nitrogen to prepare sintered material 1;
S3, crushing sintered material 1 obtained in step S2; and
S4, repeating steps S2 and S3 K times, wherein K≥1, until the delithiating material is prepared.

According to an embodiment of the present invention, the metal salt is one or more selected from the group consisting of Li₅FeO₄, Li₂NiO₂, Li₆CoO₄ and Li₆MnO₄.

According to an embodiment of the present invention, the manganese compound is selected from the group consisting of manganese sulfate, manganese nitrate, manganese chloride, and manganese bromide.

According to an embodiment of the present invention, the temperature of the heat treatment in step S1 is in the range from 300° C. to 900° C.

According to an embodiment of the present invention, preferably, the temperature of the heat treatment in step S1 is in the range from 500° C. to 800° C.

According to an embodiment of the present invention, the duration of the heat treatment in step S1 is in the range from 10 hours to 50 hours.

According to an embodiment of the present invention, preferably, the duration of the heat treatment in step S1 is in the range from 20 hours to 40 hours.

According to an embodiment of the present invention, the total content of free water and crystal water in the precursor after heat treatment in step S1 is controlled below 0.001% by molar.

According to an embodiment of the present invention, the molar ratio of lithium powder to lithium halide is in the range from 2:3 to 5:3.

According to an embodiment of the present invention, preferably, the molar ratio of lithium powder to lithium halide is in the range from 2:3 to 3:3.

According to an embodiment of the present invention, the total lithium content in lithium powder and lithium halide is 0.01% to 10% by molar higher than the lithium content in the delithiating material.

According to an embodiment of the present invention, preferably, the total lithium content in lithium powder and lithium halide is 0.1% to 5% by molar higher than the lithium content in the delithiating material.

According to an embodiment of the present invention, the pressure in sintering in steps S2 and S4 is in the range from 10 bar to 100 bar.

According to an embodiment of the present invention, preferably, the pressure in sintering in steps S2 and S4 is in the range from 30 bar to 50 bar.

According to an embodiment of the present invention, the sintering is a multi-stage sintering, in which the temperature is rapidly increased to a temperature plateau T1 at a heating rate V1 and maintained for a time t1, and then rapidly cooled to a temperature plateau T2 at a cooling rate V2 and maintained for a time t2.

According to an embodiment of the present invention, both the heating rate V1 and the cooling rate V2 are not lower than 10° C./min, 700° C.≤T1≤950° C., 300° C.≤T2≤500° C., 30 min≤t1≤120 min, and 5 h≤t2≤8 h.

According to an embodiment of the present invention, at a charging voltage of 3-4.5 V, the lithium ion battery prepared from delithiating material K formed by repeating steps S2 and S3 K times as the cathode material, comparing with the lithium ion battery prepared from delithiating material K−1 formed by repeating steps S2 and S3 K−1 times as the cathode material, shows a difference of less than 5 mAh/g in the initial dilithiation capacity value.

Comparing with the prior art, the present invention provides the following beneficial effects:

1. In the delithiating material of the present invention, by sintering with lithium for multiple times, Li₃N is inserted into the lattice of the material. Li₉N₂X₃ forms a eutectic with the base material, which further reduces the surface residue, improves the storage and cycling performance of the material, and fully utilizes Li₃N as a fast ion conductor. Together with the base material, the components complement each other and coexist synergistically.

2. In the present invention, by improving and optimizing the sintering process, the obtained delithiating material has the advantages of stable performance and easy storage.

3. The lithium ion battery prepared from the delithiating material of the present invention as the cathode material has an initial dilithiation capacity of over 400 mAh/g, preferably over 600 mAh/g, and therefore has a high dilithiation capacity, thereby reducing the amount of addition and further reducing production costs.

### BRIEF DESCRIPTION OF THE DRAWINGS

FIG. 1 is the SEM graph of the material prepared in Example 11; and

FIG. 2 is the graph of the initial charging capacity of the battery prepared from the material prepared in Example 11.

### DETAILED DESCRIPTION

Exemplary embodiments reflecting the features and advantages of the present invention will be described in detail in the following description. It should be understood that various changes can be made to different embodiments without departing from the scope of the present invention, and the description herein are for illustrative purposes in nature rather than limiting the present invention.

According to an embodiment of the present invention, there is provided a delithiating material with a chemical formula Li_{(9x+2y+z)}Mn_{y}Me_{z}O_{(3y+z)}N₂ₓX₃ₓ (xLi₉N₂X₃·yLi₂MnO₃·zA), wherein 0<x≤0.25, 0<y≤0.5, 0.5≤z≤1, Me is Fe, Ni or Co, A is selected from the group consisting of Li₅FeO₄, Li₂NiO₂, Li₆CoO₄ and Li₆MnO₄, and X is a group VIIA element.

In an embodiment of the present invention, each of x, y and z is an integral multiple of 0.05.

In an embodiment of the present invention, X is one or more selected from the group consisting of F, Cl, Br and I.

The delithiating material of the present invention has advantages such as high dilithiation capacity, stable structure, easy storage, and low capacity loss.

According to an embodiment of the present invention, there is provided a method for preparing the above delithiating material, comprising:
S1, preparing a precursor from a metal salt and a manganese compound by chemical co-precipitation, followed by, sequentially, heat treatment in a nitrogen atmosphere, crushing and sieving;
S2, adding the sieved precursor obtained in step S1 to lithium powder and lithium halide, mixing uniformly in a nitrogen atmosphere, pressing into a film, and then sintering under pressure in nitrogen to prepare sintered material 1;
S3, crushing sintered material 1 obtained in step S2;
S4, repeating steps S2 and S3 K times, wherein K≥1, until the delithiating material is prepared. At a charging voltage of 3-4.5 V, the lithium ion battery prepared from delithiating material K formed by repeating steps S2 and S3 K times as the cathode material, comparing with the lithium ion battery prepared from delithiating material K−1 formed by repeating steps S2 and S3 K−1 times as the cathode material, shows a difference of less than 5 mAh/g in the initial dilithiation capacity value.

In an embodiment of the present invention, the metal salt is one or more selected from the group consisting of Li₅FeO₄, Li₂NiO₂, Li₆CoO₄ and Li₆MnO₄.

In an embodiment of the present invention, the manganese compound is selected from the group consisting of manganese sulfate, manganese nitrate, manganese chloride, and manganese bromide.

In an embodiment of the present invention, the temperature of the heat treatment in step S1 is in the range from 300° C. to 900° C., such as 300° C., 400° C., 550° C., 600° C., 700° C., 850° C. or 900° C.

In an embodiment of the present invention, preferably, the temperature of the heat treatment in step S1 is in the range from 500° C. to 800° C., such as 500° C., 650° C., 750° C. or 800° C.

In an embodiment of the present invention, the duration of the heat treatment in step S1 is in the range from 10 hours to 50 hours, such as 10 hours, 25 hours, 35 hours, 45 hours or 50 hours.

In an embodiment of the present invention, preferably, the duration of the heat treatment in step S1 is in the range from 20 hours to 40 hours, such as 20 hours, 30 hours or 40 hours.

In an embodiment of the present invention, the total content of free water and crystal water in the precursor after heat treatment in step S1 is controlled below 0.001% by molar, such as 0.001%, 0.0008%, 0.0006%, 0.0004% or 0.0002%.

In an embodiment of the present invention, the lithium halide may be for example LiF, LiCl, LiBr or LiI.

In an embodiment of the present invention, the molar ratio of lithium powder to lithium halide is in the range from 2:3 to 5:3, such as 2:3, 4:3 or 5:3.

In an embodiment of the present invention, preferably, the molar ratio of lithium powder to lithium halide is in the range from 2:3 to 3:3, such as 2.2:3, 2.5:3 or 2.8:3.

In an embodiment of the present invention, the total lithium content in lithium powder and lithium halide is 0.01% to 10% by molar, such as 0.01%, 1%, 6% or 10%, higher than the lithium content in the delithiating material.

In an embodiment of the present invention, preferably, the total lithium content in lithium powder and lithium halide is 0.1% to 5% by molar, such as 0.1%, 2%, 3%, 4% or 5%, higher than the lithium content in the delithiating material.

In an embodiment of the present invention, the pressure in sintering in steps S2 and S4 is in the range from 10 bar to 100 bar, such as 10 bar, 20 bar, 60 bar, 80 bar or 100 bar.

In an embodiment of the present invention, preferably, the pressure in sintering in steps S2 and S4 is in the range from 30 bar to 50 bar, such as 30 bar, 40 bar or 50 bar.

In an embodiment of the present invention, the sintering is a multi-stage sintering, in which the temperature is rapidly increased to a temperature plateau T1 at a heating rate V1 and maintained for a time t1, and then rapidly cooled to a temperature plateau T2 at a cooling rate V2 and maintained for a time t2.

In an embodiment of the present invention, the heating rate V1 and the cooling rate V2 are not lower than 10° C./min, such as 10° C./min, 20° C./min, 30° C./min, 50° C./min or 100° C./min.

In an embodiment of the present invention, 700° C.≤T1≤950° C., for example, T1 is 700° C., 750° C., 800° C., 850° C., 900° C. or 950° C.

In an embodiment of the present invention, 300° C.≤T2≤500° C., for example, T2 is 300° C., 350° C., 400° C., 450° C. or 500° C.

In an embodiment of the present invention, 30 min≤t1≤120 min, for example, t1 is 30 min, 50 min, 80 min, 100 min or 120 min.

In an embodiment of the present invention, 5 h≤t2≤8 h, for example, t2 is 5 h, 6 h, 7 h or 8 h.

The method for preparing the delithiated material of the present invention is simple. By sintering with lithium for multiple times, Li₃N is inserted into the lattice of the material. Li₉N₂X₃ forms a eutectic with the base material, which further reduces the surface residue, improves the storage and cycling performance of the material, and fully utilizes Li₃N as a fast ion conductor. Together with the base material, the components complement each other and coexist synergistically, so that the obtained delithiating material has the advantages of stable structure, stable performance, and high dilithiation capacity, among others.

In the sintering process, the temperature is first raised to a higher temperature plateau to activate the crystal boundary in the material, so that it can obtain enough energy for migration and diffusion, and then quickly reduced to a lower temperature range and maintained the temperature to prevent the crystal grains of the material from growing too large, so that lithium ions are more sufficiently inserted into the crystal boundary to further improve the performance of the material.

Hereinbelow, the delithiating material of the present invention and its preparation method will be further described with reference to specific examples.

The Examples of the present invention were carried out according to the following method:

A precursor was prepared from a metal salt and a manganese compound by chemical co-precipitation, followed by, sequentially, heat treatment and crushing; lithium powder and lithium halide were added to the precursor, mixed uniformly in a nitrogen atmosphere, pressed into a film, and sintered under pressure in nitrogen to prepare sintered material 1, which was crushed again; the process of adding lithium powder and lithium halide, mixing uniformly in a nitrogen atmosphere, pressing into a film, sintering under pressure in nitrogen and crushing was repeated until a delithiating material was formed. The delithiating material has a chemical formula Li_{(9x+2y+z)}Mn_{y}Me_{z}O_{(3y+z)}N₂ₓX₃ₓ (xLi₉N₂X₃·yLi₂MnO₃·zA), wherein 0<x≤0.25, 0<y≤0.5, 0.5≤z≤1, Me is Fe, Ni or Co, A is one or more selected from the group consisting of Li₅FeO₄, Li₂NiO₂, Li₆CoO₄ and Li₆MnO₄, and X is a group VIIA element.

### Example 1

The metal salt was 10 kg of a mixture of analytically pure Li₂NiO₂ and analytically pure Li₅FeO₄ in a molar ratio of 1:1, which was formulated with 1 kg of analytically pure manganese sulfate into a solution comprising 1 mol/L sulfate. 5 L of the sulfate solution, 8 L of 1 mol/L sodium hydroxide solution, and 0.2 L of 10 mol/L aqueous ammonia were added to a reaction vessel to carry out the reaction. The precipitate was filtered, washed and dried to give the precursor, which was then heat treated in a nitrogen atmosphere and crushed, wherein the conditions of the heat treatment comprised heating at 700° C. for 40 hours, and the crushing was carried out until the median particle size D₅₀ of the precursor was 15 m. To the crushed precursor was added a mixture of lithium powder and lithium chloride in a molar ratio of 2:3. The materials were mixed uniformly in a nitrogen atmosphere and pressed into a film, and then sintered under pressure in nitrogen to prepare sintered material 1, which was crushed again until the median particle size D₅₀ was 15 m. The following process was repeated 4 times to prepare the delithiating material: adding 100 g of the mixture of lithium powder and lithium chloride in a molar ratio of 2:3 to the crushed sintered material 1; mixing uniformly in a nitrogen atmosphere and pressing into a film; sintering under pressure in nitrogen; and crushing until the median particle size D₅₀ was 15 km. At a charging voltage of 3-4.5 V, the lithium ion battery prepared from delithiating material 4 formed by repeating 4 times as the cathode material, comparing with the lithium ion battery prepared from delithiating material 3 formed by repeating 3 times as the cathode material, showed a difference of 3 mAh/g in the initial dilithiation capacity value. The total lithium content in the added mixture of lithium powder and lithium chloride was 0.1 mol % higher than the lithium content in the finally prepared delithiating material. All the above sinterings were multi-stage sinterings, in which the temperature was rapidly increased to a temperature plateau T1 at a heating rate V1 and maintained for a time t1, and then rapidly cooled to a temperature plateau T2 at a cooling rate V2 and maintained for a time t2, wherein the sintering pressure was 30 bar, V1=15° C./min, T1=800° C., t1=60 min, V2=15° C./min, T2=400° C., t2=6 h. The delithiating material has a chemical formula Li_{(9x+2y+z)}Mn_{y}Me_{z}O_{(3y+z)}N₂ₓX₃ₓ (xLi₉N₂X₃·yLi₂MnO₃·zA), wherein x is 0.05, y is 0.25, z is 0.7, Me is Fe and Ni, A is Li₂NiO₂ and Li₅FeO₄, and X is Cl.

### Example 2

The preparation method was the same as that in Example 1, except that the selected metal salt was a mixture of analytically pure Li₂NiO₂ and analytically pure Li₅FeO₄ in a molar ratio of 4:1. At a charging voltage of 3-4.5 V, the lithium ion battery prepared from delithiating material 4 formed by repeating 4 times as the cathode material, comparing with the lithium ion battery prepared from delithiating material 3 formed by repeating 3 times as the cathode material, showed a difference of 3.5 mAh/g in the initial dilithiation capacity value. In the delithiating material, x is 0.05, y is 0.35, and z is 0.6.

### Example 3

The preparation method was the same as that in Example 1, except that the selected metal salt was a mixture of analytically pure Li₂NiO₂ and analytically pure Li₅FeO₄ in a molar ratio of 3:2. At a charging voltage of 3-4.5 V, the lithium ion battery prepared from delithiating material 4 formed by repeating 4 times as the cathode material, comparing with the lithium ion battery prepared from delithiating material 3 formed by repeating 3 times as the cathode material, showed a difference of 3.6 mAh/g in the initial dilithiation capacity value. In the delithiating material, x is 0.1, y is 0.25, and z is 0.65.

### Example 4

The preparation method was the same as that in Example 1, except that the selected metal salt was analytically pure Li₂NiO₂. At a charging voltage of 3-4.5 V, the lithium ion battery prepared from delithiating material 4 formed by repeating 4 times as the cathode material, comparing with the lithium ion battery prepared from delithiating material 3 formed by repeating 3 times as the cathode material, showed a difference of 4.3 mAh/g in the initial dilithiation capacity value. In the delithiating material, x is 0.15, y is 0.35, z is 0.5, Me is Ni, and A is Li₂NiO₂.

### Example 5

The preparation method was the same as that in Example 1, except that the selected metal salt was a mixture of analytically pure Li₂NiO₂ and analytically pure Li₅FeO₄ in a molar ratio of 2:3. At a charging voltage of 3-4.5 V, the lithium ion battery prepared from delithiating material 4 formed by repeating 4 times as the cathode material, comparing with the lithium ion battery prepared from delithiating material 3 formed by repeating 3 times as the cathode material, showed a difference of 4 mAh/g in the initial dilithiation capacity value. In the delithiating material, x is 0.2, y is 0.15, and z is 0.65.

### Example 6

The preparation method was the same as that in Example 1, except that the selected metal salt was analytically pure Li₅FeO₄. At a charging voltage of 3-4.5 V, the lithium ion battery prepared from delithiating material 4 formed by repeating 4 times as the cathode material, comparing with the lithium ion battery prepared from delithiating material 3 formed by repeating 3 times as the cathode material, showed a difference of 3.9 mAh/g in the initial dilithiation capacity value. In the delithiating material, x is 0.2, y is 0.25, z is 0.55, Me is Fe, and A is Li₅FeO₄.

### Example 7

The preparation method was the same as that in Example 1, except that the conditions of the heat treatment comprised heating at 600° C. for 20 hours; and a mixture of lithium powder and lithium bromide in a molar ratio of 2.5:3 was added to the crushed precursor. At a charging voltage of 3-4.5 V, the lithium ion battery prepared from delithiating material 4 formed by repeating 4 times as the cathode material, comparing with the lithium ion battery prepared from delithiating material 3 formed by repeating 3 times as the cathode material, showed a difference of 3.8 mAh/g in the initial dilithiation capacity value. The sintering pressure was 40 bar, V1=15° C./min, T1=700° C., t1=90 min, V2=15° C./min, T2=450° C., t2=6 h. In the delithiating material, X is Br.

### Example 8

The preparation method was the same as that in Example 1, except that the conditions of the heat treatment comprised heating at 600° C. for 20 hours; and a mixture of lithium powder and lithium iodide in a molar ratio of 2.5:3 was added to the crushed precursor. At a charging voltage of 3-4.5 V, the lithium ion battery prepared from delithiating material 4 formed by repeating 4 times as the cathode material, comparing with the lithium ion battery prepared from delithiating material 3 formed by repeating 3 times as the cathode material, showed a difference of 2.5 mAh/g in the initial dilithiation capacity value. The total lithium content in the added mixture of lithium powder and lithium iodide was 0.5 mol % higher than the lithium content in the delithiating material. The sintering pressure was 50 bar, V1=15° C./min, T1=750° C., t1=90 min, V2=15° C./min, T2=550° C., t2=7 h. In the delithiating material, X is I.

### Example 9

The preparation method was the same as that in Example 1, except that the selected metal salt was analytically pure Li₂NiO₂; and that to the crushed precursor was added a mixture of lithium powder and lithium chloride in a molar ratio of 2.5:3. At a charging voltage of 3-4.5 V, the lithium ion battery prepared from delithiating material 4 formed by repeating 4 times as the cathode material, comparing with the lithium ion battery prepared from delithiating material 3 formed by repeating 3 times as the cathode material, showed a difference of 4.6 mAh/g in the initial dilithiation capacity value. The total lithium content in the added mixture of lithium powder and lithium chloride was 0.3 mol % higher than the lithium content in the delithiating material. The sintering pressure was 30 bar, V1=15° C./min, T1=750° C., t1=60 min, V2=15° C./min, T2=500° C., t2=5 h. In the delithiating material, x is 0.05, y is 0.25, z is 0.7, Me is Ni, and A is Li₂NiO₂.

### Example 10

The preparation method was the same as that in Example 9, except that the selected metal salt was a mixture of analytically pure Li₂NiO₂ and analytically pure Li₅FeO₄ in a molar ratio of 4:1. At a charging voltage of 3-4.5 V, the lithium ion battery prepared from delithiating material 4 formed by repeating 4 times as the cathode material, comparing with the lithium ion battery prepared from delithiating material 3 formed by repeating 3 times as the cathode material, showed a difference of 4.7 mAh/g in the initial dilithiation capacity value. In the delithiating material, x is 0.05, y is 0.35, and z is 0.6.

### Example 11

The preparation method was the same as that in Example 9, except that the selected metal salt was a mixture of analytically pure Li₂NiO₂ and analytically pure Li₅FeO₄ in a molar ratio of 3:2. In the delithiating material, x is 0.1, y is 0.25, z is 0.65, and A is Li₂NiO₂ and Li₅FeO₄.

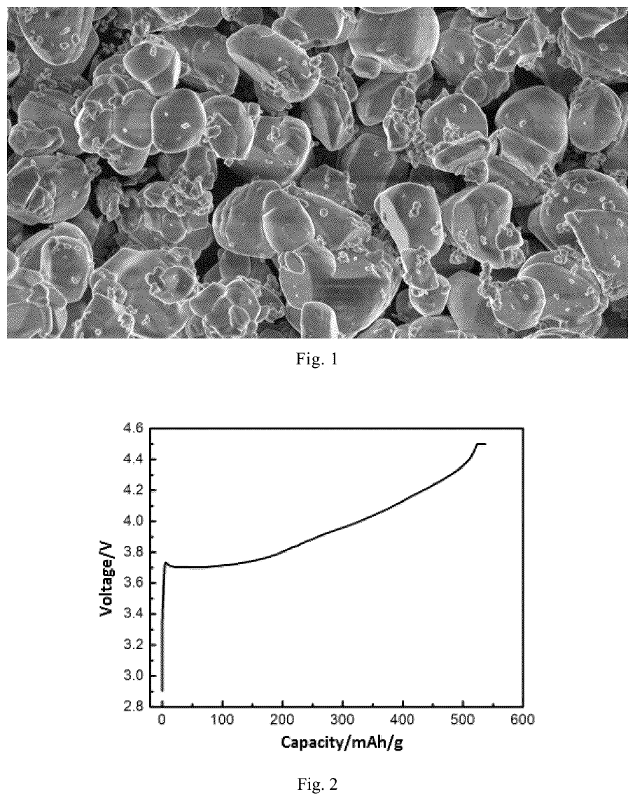

FIG. 1 is the SEM graph of the material prepared in Example 11; and

FIG. 2 is the graph of the initial charging capacity of the battery prepared from the material prepared in Example 11.

### Example 12

The preparation method was the same as that in Example 9, except that the selected metal salt was a mixture of analytically pure Li₂NiO₂ and analytically pure Li₅FeO₄ in a molar ratio of 1:1. At a charging voltage of 3-4.5 V, the lithium ion battery prepared from delithiating material 4 formed by repeating 4 times as the cathode material, comparing with the lithium ion battery prepared from delithiating material 3 formed by repeating 3 times as the cathode material, showed a difference of 4.5 mAh/g in the initial dilithiation capacity value. In the delithiating material, x is 0.15, y is 0.35, and z is 0.5.

### Example 13

The preparation method was the same as that in Example 9, except that the selected metal salt was a mixture of analytically pure Li₂NiO₂ and analytically pure Li₅FeO₄ in a molar ratio of 2:3. At a charging voltage of 3-4.5 V, the lithium ion battery prepared from delithiating material 4 formed by repeating 4 times as the cathode material, comparing with the lithium ion battery prepared from delithiating material 3 formed by repeating 3 times as the cathode material, showed a difference of 3.8 mAh/g in the initial dilithiation capacity value. In the delithiating material, x is 0.2, y is 0.15, and z is 0.65.

### Example 14

The preparation method was the same as that in Example 9, except that the selected metal salt was analytically pure Li₅FeO₄. At a charging voltage of 3-4.5 V, the lithium ion battery prepared from delithiating material 4 formed by repeating 4 times as the cathode material, comparing with the lithium ion battery prepared from delithiating material 3 formed by repeating 3 times as the cathode material, showed a difference of 3.7 mAh/g in the initial dilithiation capacity value. In the delithiating material, x is 0.2, y is 0.25, z is 0.55, Me is Fe, and A is Li₅FeO₄.

### Example 15

The preparation method was the same as that in Example 1, except that the conditions of the heat treatment comprised heating at 800° C. for 30 hours; and a mixture of lithium powder and lithium fluoride in a molar ratio of 3:3 was added to the crushed precursor. At a charging voltage of 3-4.5 V, the lithium ion battery prepared from delithiating material 4 formed by repeating 4 times as the cathode material, comparing with the lithium ion battery prepared from delithiating material 3 formed by repeating 3 times as the cathode material, showed a difference of 3.5 mAh/g in the initial dilithiation capacity value. The total lithium content in the added mixture of lithium powder and lithium fluoride was 0.5 mol % higher than the lithium content in the delithiating material. The sintering pressure was 100 bar, V1=15° C./min, T1=900° C., t1=100 min, V2=15° C./min, T2=500° C., t2=8 h. In the delithiating material, X is F.

### Example 16

The preparation method was the same as that in Example 1, except that the selected metal salt was a mixture of analytically pure Li₆CoO₄ and analytically pure Li₆MnO₄ in a molar ratio of 1:1; the conditions of the heat treatment comprised heating at 700° C. for 30 hours; and a mixture of lithium powder and lithium chloride in a molar ratio of 3:3 was added to the crushed precursor. At a charging voltage of 3-4.5 V, the lithium ion battery prepared from delithiating material 4 formed by repeating 4 times as the cathode material, comparing with the lithium ion battery prepared from delithiating material 3 formed by repeating 3 times as the cathode material, showed a difference of 4.1 mAh/g in the initial dilithiation capacity value. The total lithium content in the added mixture of lithium powder and lithium chloride was 0.5 mol % higher than the lithium content in the delithiating material. The sintering pressure was 100 bar, V1=15° C./min, T1=900° C., t1=100 min, V2=15° C./min, T2=500° C., t2=8 h. In the delithiating material, Me is Co, A is Li₆CoO₄ and Li₆MnO₄.

### Comparative Example 1

The metal salt was 10 kg of analytically pure Li₂NiO₂, which was formulated with 1 kg of analytically pure manganese sulfate into a solution comprising 1 mol/L sulfate. 5 L of the sulfate solution, 8 L of 1 mol/L sodium hydroxide solution, and 0.2 L of 10 mol/L aqueous ammonia were added to a reaction vessel to carry out the reaction. The precipitate was filtered, washed and dried to give the precursor, which was then heat treated in a nitrogen atmosphere and crushed, wherein the conditions of the heat treatment comprised heating at 600° C. for 30 hours, and the crushing was carried out until the median particle size D₅₀ of the precursor was m. To the crushed precursor was added a mixture of lithium powder and lithium chloride in a molar ratio of 2:3. The materials were mixed uniformly in a nitrogen atmosphere and pressed into a film, and then sintered under pressure in nitrogen to prepare sintered material 1, which was crushed again until the median particle size D₅₀ was 15 m. The following process was repeated 4 times to prepare the delithiating material: adding 100 g of the mixture of lithium powder and lithium chloride in a molar ratio of 2:3 to the crushed sintered material 1; mixing uniformly in a nitrogen atmosphere and pressing into a film; sintering under pressure in nitrogen; and crushing until the median particle size D₅₀ was 15 km. At a charging voltage of 3-4.5 V, the lithium ion battery prepared from delithiating material 4 formed by repeating 4 times as the cathode material, comparing with the lithium ion battery prepared from delithiating material 3 formed by repeating 3 times as the cathode material, showed a difference of 25 mAh/g in the initial dilithiation capacity value. The total lithium content in the added mixture of lithium powder and lithium chloride was 0.2 mol % higher than the lithium content in the finally prepared delithiating material. The sintering process did not comprise a multi-stage sintering; instead, the temperature was rapidly increased to a temperature plateau T1 at a heating rate V1 and maintained for a time t1. The sintering pressure was 30 bar, V1=15° C./min, T1=800° C., t1=12 h. The delithiating material has a chemical formula Li_{(9x+2y+z)}Mn_{y}Me_{z}O_{(3y+z)}N₂ₓX₃ₓ (xLi₉N₂X₃·yLi₂MnO₃·zA), wherein x is 0.05, y is 0.25, z is 0.7, Me is Ni, A is Li₂NiO₂, and X is Cl.

### Comparative Example 2

The preparation method was the same as that in Comparative Example 1, except that the selected metal salt was a mixture of analytically pure Li₂NiO₂ and analytically pure Li₅FeO₄ in a molar ratio of 4:1. At a charging voltage of 3-4.5 V, the lithium ion battery prepared from delithiating material 4 formed by repeating 4 times as the cathode material, comparing with the lithium ion battery prepared from delithiating material 3 formed by repeating 3 times as the cathode material, showed a difference of 21 mAh/g in the initial dilithiation capacity value. In the delithiating material, x is 0.05, y is 0.35, z is 0.6, Me is Ni and Fe, and A is Li₂NiO₂ and Li₅FeO₄.

### Comparative Example 3

The preparation method was the same as that in Comparative Example 1, except that the selected metal salt was a mixture of analytically pure Li₂NiO₂ and analytically pure Li₅FeO₄ in a molar ratio of 3:2. At a charging voltage of 3-4.5 V, the lithium ion battery prepared from delithiating material 4 formed by repeating 4 times as the cathode material, comparing with the lithium ion battery prepared from delithiating material 3 formed by repeating 3 times as the cathode material, showed a difference of 18 mAh/g in the initial dilithiation capacity value. In the delithiating material, x is 0.1, y is 0.25, z is 0.65, Me is Ni and Fe, and A is Li₂NiO₂ and Li₅FeO₄.

### Comparative Example 4

The preparation method was the same as that in Comparative Example 1, except that the selected metal salt was Li₅FeO₄. At a charging voltage of 3-4.5 V, the lithium ion battery prepared from delithiating material 4 formed by repeating 4 times as the cathode material, comparing with the lithium ion battery prepared from delithiating material 3 formed by repeating 3 times as the cathode material, showed a difference of 29 mAh/g in the initial dilithiation capacity value. In the delithiating material, x is 0.2, y is 0.25, z is 0.55, Me is Fe, and A is Li₅FeO₄.

### Comparative Example 5

The preparation method was the same as that in Comparative Example 1, except that the conditions of the heat treatment comprised heating at 800° C. for 30 hours; and a mixture of lithium powder and lithium chloride in a molar ratio of 3:3 was added to the crushed precursor. At a charging voltage of 3-4.5 V, the lithium ion battery prepared from delithiating material 4 formed by repeating 4 times as the cathode material, comparing with the lithium ion battery prepared from delithiating material 3 formed by repeating 3 times as the cathode material, showed a difference of 26 mAh/g in the initial dilithiation capacity value. The lithium powder further comprised powders of lithium carbonate and lithium hydroxide. The total lithium content in the added mixture of lithium powder and lithium chloride was 0.5 mol % higher than the lithium content in the delithiating material. Multiple-stage sinterings were configured, wherein the sintering pressure was 30 bar, T1=900° C., T2=500° C., t1=100 min, t2=8 h, and the sintering process was repeated 4 times.

### Comparative Example 6

The preparation method was the same as that in Comparative Example 1, except that the conditions of the heat treatment comprised heating at 800° C. for 30 hours; and a mixture of lithium powder and lithium chloride in a molar ratio of 3:3 was added to the crushed precursor. The lithium powder further comprised powders of lithium carbonate and lithium hydroxide. At a charging voltage of 3-4.5 V, the lithium ion battery prepared from delithiating material 4 formed by repeating 4 times as the cathode material, comparing with the lithium ion battery prepared from delithiating material 3 formed by repeating 3 times as the cathode material, showed a difference of 31 mAh/g in the initial dilithiation capacity value. The total lithium content in the added mixture of lithium powder and lithium chloride was 0.5 mol % higher than the lithium content in the delithiating material. Multiple-stage sinterings were configured, wherein the sintering pressure was 30 bar, T1=900° C., T2=500° C., t1=100 min, t2=8 h, and the sintering process was repeated 4 times. In the delithiating material, x is 0.2, y is 0.3, and z is 0.5.

A lithium ion battery was prepared using a sample obtained in one of the Examples and Comparative Examples as the cathode material, graphite as the anode material, and a solution of lithium hexafluorophosphate in ethyl carbonate as the electrolyte. The initial charging capacity of the battery at 3-4.5 V was determined according to YS/T 798-2012 “Lithium nickel cobalt manganese oxide”.

The capacity loss of the sample stored at dew point −50° C. under dry condition for 5 days or the capacity loss of the sample stored under a relative humidity of 10% for 10 h was obtained by subtracting the initial charging capacity obtained for the sample stored at dew point −50° C. under dry condition for 5 days or subtracting the initial charging capacity obtained for the sample stored under a relative humidity of 10% for 10 h from the initial charging capacity obtained for the freshly prepared sample.

For the samples obtained in Examples 1 to 14 and Comparative Examples 1 to 4, the initial dilithiation capacities of the lithium ion batteries prepared using the samples as cathode materials tested at charging voltage of 3-4.5 V, the capacity losses of the samples stored at dew point −50° C. under dry condition for 5 days, and the capacity losses of the samples stored under a relative humidity of 10% for 10 h are shown in Table 1.

TABLE 1
Test results of the initial charging capacity and the capacity loss

| | Charging | Capacity Loss, % | |
|---|---|---|---|
| | voltage 3-4.5 V | | Relative humidity |
| | Initial delithiation | Dew point −50° C., | of 10%, store |
| Examples | capacity/mAh/g | dry, store for 5 days | for 10 h |
| Example 1 | 483 | 5.1 | 4.9 |
| Example 2 | 452 | 4.6 | 5.6 |
| Example 3 | 532 | 6.3 | 6.5 |
| Example 4 | 420 | 3.2 | 5.3 |
| Example 5 | 566 | 7.8 | 8.1 |
| Example 6 | 631 | 9.4 | 10.2 |
| Example 9 | 435 | 2.9 | 4.2 |
| Example 10 | 462 | 4.6 | 4.7 |
| Example 11 | 552 | 6.1 | 5.5 |
| Example 12 | 493 | 4.5 | 5.3 |
| Example 13 | 581 | 6.3 | 7.8 |
| Example 14 | 628 | 8.4 | 10.8 |
| Comparative | 215 | 12.9 | 13.5 |
| Example 1 | | | |
| Comparative | 272 | 15.6 | 12.2 |
| Example 2 | | | |
| Comparative | 312 | 23.1 | 23.4 |
| Example 3 | | | |
| Comparative | 350 | 30.4 | 28.6 |
| Example 4 | | | |

It can be seen from Table 1 that the lithium ion batteries prepared from the delithiating materials prepared in Examples 1 to 6 and 9 to 14 of the present invention show initial dilithiation capacities of more than 400 mAh/g, even as high as 631 mAh/g. In comparison, for the samples prepared in Comparative Examples 1 to 4, the initial dilithiation capacities of can only reach 350 mAh/g at the highest. Therefore, the delithiating material of the present invention has the advantage of high dilithiation capacity. At the same time, in terms of the capacity loss tested by storing at dew point −50° C. under dry condition for 5 days and by storing under a relative humidity of 10% for 10 h, the samples prepared in Examples 1 to 6 and Examples 9 to 14 show much lower capacity losses than the samples prepared in Comparative Examples 1-4. These also confirm from the practical point of view that the delithiating material of the present invention has excellent performance of stable performance and easy storage.

It should be noted by a person skilled in the art that the described embodiments of the present invention are merely exemplary, and various other replacements, changes and improvements may be made within the scope of the present invention. Therefore, the present invention is not limited to the above-described embodiments, but only by the claims.

1. A lithium ion battery with low capacity loss, which comprises:
an cathode material, which has a chemical formula Li_{(9x+2y+z)}Mn_{y}Me_{z}O_{(3y+z)}N₂ₓX₃ₓ (xLi₉N₂X₃·yLi₂MnO₃·zA), wherein 0<x≤0.25, 0<y≤0.5, 0.5≤z≤1, Me is Fe, Ni or Co, A is one or more selected from the group consisting of Li₅FeO₄, Li₂NiO₂, Li₆CoO₄ and Li₆MnO₄, and X is a group VIIA element;
a anode material; and
an electrolyte.

2. The lithium ion battery according to claim 1, wherein each of x, y and z is an integral multiple of 0.05; X is one or more selected from the group consisting of F, Cl, Br and I.

3. The lithium ion battery according to claim 1, wherein the cathode material is prepared by a method comprising:
S1, preparing a precursor from a metal salt and a manganese compound by chemical co-precipitation, followed by, sequentially, heat treatment in a nitrogen atmosphere, crushing and sieving, wherein the metal salt is one or more selected from the group consisting of Li₅FeO₄, Li₂NiO₂, Li₆CoO₄ and Li₆MnO₄;
S2, adding the sieved precursor obtained in step S1 to lithium powder and lithium halide, mixing uniformly in a nitrogen atmosphere, pressing into a film, and then sintering under pressure in nitrogen to prepare sintered material 1;
S3, crushing sintered material 1 obtained in step S2; and
S4, repeating steps S2 and S3 K times, wherein K≥1.

4. The lithium ion battery according to claim 3, wherein in the heat treatment in step S1, the temperature is in the range from 300° C. to 900° C., and the duration is in the range from 10 hours to 50 hours.

5. The lithium ion battery according to claim 3, wherein the total content of free water and crystal water in the precursor after heat treatment in step S1 is controlled below 0.001% by molar.

6. The lithium ion battery according to claim 3, wherein the molar ratio of lithium powder to lithium halide is in the range from 2:3 to 5:3.

7. The lithium ion battery according to claim 3, wherein the total lithium content in lithium powder and lithium halide is 0.01% to 10% by molar higher than the lithium content in the delithiating material.

8. The lithium ion battery according to claim 3, wherein in step S2, the sintering comprises:
increasing the temperature to a temperature plateau T1 at a heating rate V1 and maintaining for a time t1, and then cooling to a temperature plateau T2 at a cooling rate V2 and maintaining for a time t2, wherein both the heating rate V1 and the cooling rate V2 are not lower than 10° C./min, 700° C.≤T1≤950° C., 300° C.≤T2≤500° C., 30 min≤t1≤120 min, and 5 h≤t2≤8 h.

9. The lithium ion battery according to claim 3, wherein the lithium ion battery has an initial dilithiation capacity of over 400 mAh/g.

10. The lithium ion battery according to claim 3, wherein in step S4, steps S2 and S3 are repeated K times, until the lithium ion battery prepared from the delithiating material formed by repeating K times as the cathode material, comparing with the lithium ion battery prepared from the delithiating material formed by repeating K−1 times as the cathode material, shows a difference of less than 5 mAh/g in the initial dilithiation capacity value.
